(19) United States
(12) Patent Application Publication
(10) Pub. No.: US 2004/0186623 A1
(43) Pub. Date: Sep. 23, 2004

(54) Toy robot programming

(76) Inventors: Mike Dooley, San Rafael, CA (US); Gaute Munch, Langa (DK)

Correspondence Address: Gerald Levy, Pitney Hardin Kipp & Szuch, 711 Third Avenue, New York, NY, 10017-4059, US

(21) Appl. No.: 10/478,762

(22) PCT Filed: May 24, 2002
(86) PCT No.: PCT/DK02/00349

(30) Foreign Application Priority Data
May 25, 2001 (DK) PA 2001 00844
May 25, 2001 (DK) PA 2001 00845

(51) Int. Cl. G06F 19/00

(52) U.S. Cl. 700/245

(57) ABSTRACT

A method of controlling a robot (1102) having detection means (1103, 1104) for detecting an object (1109) in one of a numkber of zones relative to the robot; and processing means for selecting and performing a predetermined action in response to said detection, the action corresponding to the detected zone. the method comprises presenting to a user via a graphical user interface (1101) a number of area symbols (1106-1108) each representing a corresponding one of the zones relative to the robot; presenting via the graphical user interface a plurality of action symbols (1124-1127) each representing at least one respective action of the robot; receiving a user command indicating a placement of an action symbol in a predetermined relation to a first one of said area symbols corresponding to a first zone; and generating an instruction for controlling the toy robot to perform the corresponding action in response to detecting an object in the first zone.

### FIELD OF THE INVENTION

This invention relates to controlling a robot and, more particularly, controlling a robot, the robot including detection means for detecting an object in a first one of a number of predetermined zones relative to the robot and for generating a detection signal identifying the first zone; and processing means for selecting and performing a predetermined action from a number of actions in response to said detection signal, the predetermined action corresponding to said first zone.

### BACKGROUND OF THE INVENTION

Toy robots are a popular type of toy for children, adolescents and grown-ups. The degree of satisfaction achieved during the play with a toy robot strongly depends upon the ability of the toy robot to interact with its environment. An environment may include persons playing with a robot; different types of obstacles, e.g. furniture in a living room; other toy robots; and conditions such as temperature and intensity of light.

A toy robot repeating the same limited number of actions will soon cease to be interesting for the user. Therefore it is a major interest to increase the ability to interact with the environment. An interaction with the environment may comprise the steps of sensing the environment, making decisions, and acting. In particular, the acting should depend on the context of the game which the child wishes to engage in, for example playing tag, letting a robot perform different tasks, or the like.

A fundamental precondition for achieving such an aim of advanced interaction with the environment is the means for sensing the environment. In this context, means for communicating, for example with toy robots of the same or similar kind or species, and means for determining the position of such other toy robots are important.

The more developed means for sensing and acting a robot has, the more compound interaction it can have with the surrounding environment and the more detailed the reflection of the complexity in the environment will be. Thus, complex behaviour originates in rich means for sensing, acting and communicating.

U.S. Pat. No. 5,819,008 discloses a sensor system for preventing collisions between mobile robots and between mobile robots and other obstacles. Each mobile robot includes multiple infrared signal transmitters and infrared receivers for sending and receiving transmission data into/from different directions, the transmission data including information about the direction of motion of the transmitting robot. Each robot further comprises a control unit which controls the mobile robot to perform predetermined collision avoidance movements depending on which direction another mobile robot is detected in and which direction of motion the other robot has signalled.

However, the above prior art mobile robots repeat the same limited number of actions which soon will appear monotonous to a user. Therefore, the robot will soon cease to be interesting for the user.

Consequently, the above prior art system involves the disadvantage that the mobile robots are not able to navigate among other robots with a varying and context-dependant behaviour which a user may perceive as being intelligent.

### SUMMARY OF THE INVENTION

The above and other problems are solved when a method of controlling a robot, the robot including detection means for detecting an object in a first one of a number of predetermined zones relative to the robot and for generating a detection signal identifying the first zone, and processing means for selecting and performing a predetermined action from a number of actions in response to said detection signal, the predetermined action corresponding to said first zone is characterised in that the method comprises

presenting to a user via a graphical user interface a number of area symbols each representing a corresponding one of the number of zones relative to the robot;

presenting to the user via the graphical user interface a plurality of action symbols, each action symbol representing at least one respective action of the robot;

receiving a user command indicating a placement of an action symbol corresponding to a first action in a predetermined relation to a first one of said area symbols corresponding to a first zone; and

generating an instruction for controlling-the toy robot to perform the first action in response to detecting an object in the first zone.

Consequently, the behaviour of the robot depending on its positional relationship with other robots may be controlled by a user. A graphical user interface for programming the robot is provided which presents the spatial conditions in a way which is easy to understand for a user, even for a child with limited ability for spatial abstraction. The user is presented with a graphical representation of a number of zones around the robot and a number of action symbols, each of which represents a certain action and may be placed by the user within the different zones. Consequently, a tool for customisation and programming a robot is provided which may be used by users without advanced technical skills or abstract logic abilities.

Here, the term zone comprises a predetermined set or range of positions relative to the robot, e.g. a certain sector relative to the robot, a certain area within a plane parallel to the surface on which the robot moves, or the like. Hence, when a robot detects another robot in one of its zones, the two robots have a predetermined positional relationship, e.g. the distance between them may be within a certain range, the other robot may be located in a direction relative to the direction of motion of the detecting robot which is within a certain range of directions, or the like.

The term detection means comprises any sensor suitable for detecting a positional relationship with another object or robot. Examples of such sensors include transmitters and/or receivers for electromagnetic waves, such as radio waves, visible light, infrared light, etc. It is preferred that the means comprise infrared light emitters and receivers.

In a preferred embodiment, the robot comprises means for emitting signals to multiple zones at predetermined locations around and relative to the robot; and the means are arranged to make said signals carry information that is specific to the individual zones around the robot.

Consequently, information for determining the orientation of the robot is emitted zone-by-zone. The accuracy of the orientation is determined by the number of zones. The information that is specific for an individual zone is emitted to a location, from which location the zone can be identified. Since the information is transmitted to a predetermined location relative to the robot it is possible to determine the orientation of the robot.

In a preferred embodiment the means are arranged as individual emitters mounted with a mutual distance and at mutually offset angles to establish spatial irradiance zones around the robot. Thereby a simple embodiment for transmitting the zone specific information to respective zones is obtained.

When the information that is specific to the individual zones is emitted as a time-multiplexed signal zone-by-zone interference between signals transmitted to different zones can be avoided by controlling timing of the signals.

When at least one emitter is controlled to transmit message-signals with information about the robot to other robots the other robots can receive this information at their own discretion and interpret the information according to their own rules. The rules—typically implemented as computer programs—can in turn implement a type of behaviour. Examples of such information comprises an identification of the robot, the type of robot, or the like, information about the internal state of the robot, etc.

In a preferred embodiment of the invention, the method further comprises the step of receiving a user command indicative of an identification of at least one selected target object; and the step of generating an instruction further comprises generating an instruction for controlling the toy robot to perform the first action in response to detecting the one of the at least one selected target objects in the first zone. Consequently, the robot may be controlled to differentiate its actions depending on which robot is detected, which type of robot/object, or the like, thereby increasing the variability of possible actions which makes the robot even more interesting to interact with, since the behaviour of the robot is context-dependant. A selected target robot may be a specific robot or other device, or it may be a group of target robots, such as any robot of a certain type, any remote control, or the like. For example, game scenarios may be programmed where different robots or teams of robots cooperate with each other or compete with each other.

Other examples of detection means include magnetic sensors, radio transmitters/receivers, etc. For example, a robot may include a radio transmitter for transmitting radio waves at different power levels and different frequencies, different frequencies corresponding to different power levels. The robot may further comprise corresponding receivers for receiving such radio waves and detecting their corresponding frequencies. From the received frequencies, a robot may determine the distance to another robot.

In a preferred embodiment the means is controlled by means of a digital signal carrying the specific information.

When the detection means comprises a distance sensor adapted to generate a sensor signal indicative of a distance to the object; and each of the area symbols represents a predetermined range of distances from an object, a simple measure for distinguishing different zones is provided.

Zones may be established by controlling said means to emit said signals at respective power levels, at which power levels the signals comprise information for identifying the specific power level. Hence, information for determining the distance to a transmitter of the signals is provided.

The distance to a transmitter of the signals for determining the distance can be determined by means of a system that comprises: means for receiving signals with information for identifying a specific power level at which the signal is transmitted; and means for-converting that information into information that represents distance between the system and a transmitter that transmits the signals.

In a preferred embodiment of the invention, the detection means comprises direction sensor means adapted to generate a sensor signal indicative of a direction to the object; and each of the area symbols represents a predetermined range of directions to an object.

The system can comprise means for receiving signals that carry information that is specific to one of multiple zones around and relative to a remote robot; and means for extracting the information specific to an individual zone and converting that information into information that represents the orientation of the remote robot. Thereby transmitted signals with information about the orientation of a robot as mentioned above is received and converted into a representation of the orientation of the remote robot. This knowledge of a remote robot's orientation can be used for various purposes: for tracking or following movements of the remote robot, for perceiving a behavioural state of the remote robot signalled by physical movements of the robot.

In a preferred embodiment of the invention, the detection means comprises orientation sensor means adapted to generate a sensor signal indicative of an orientation of the object; and each of the area symbols represents a predetermined range of orientations of an object.

Hence, when the system comprises means for receiving signals from a remote robot, and determining a direction to the remote robot by determining a direction of incidence of the received signals, both orientation of and direction to the remote robot is known. Thereby signals transmitted from a remote robot for the purpose of determining its orientation can also be used for determining the direction to the remote robot. The direction of incidence can be determined e.g. by means of an array of detectors that each are placed with mutually offset angles.

Here the term object comprises any physical object which is detectable by the detecting means. Examples of objects comprise other robots, remote controls or robot controllers, other stationary transmitting/receiving devices for signals which may be detected by the detecting means of the robot. Further examples comprise objects which reflect the signals emitted by the robot, etc.

The term processing means comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, other suitable processing units, etc., or a combination thereof.

An action may be a simple physical action of a robot, such as moving forward for a predetermined time or distance, rotate by a predetermined angle, produce a sound via a loud speaker, activate light emitters, such as LEDs or the like, move movable parts of the robot, such as lifting an arm, rotating a head, or the like.

In a preferred embodiment, each of the action symbols corresponds to a sequence of predetermined physical actions of the toy robot. Examples of such a sequence of actions may comprise moving backwards for a short distance, rotating to the left, and moving forward, resulting in a more complex action of moving around an obstacle. It is an advantage of the invention that complex and compound behaviour depending on the detection of positional relationships with objects such as other robots may easily be programmed.

The area symbols may comprise any suitable graphical representation of a zone. Examples of area symbols comprise circles, ellipses or other shapes positioned and extending around the position of the robot in a way corresponding to the position and extension of the detection zones of the above detecting means. The position of the robot may be indicated by a predetermined symbol or, preferably by an image of the robot, a drawing, or the like.

The action symbols may be icons or other symbols representing different actions. Different actions may be distinguished by different icons, colours, shapes, or the like. The action symbols may be control elements of the graphical user interface and adapted to be activated by a pointing device to generate a control signal causing the above processing means to generate a corresponding instruction. In a preferred embodiment, the action symbols may be activated via a drag-and-drop operation positioning the action symbol in relation to one of the area symbols, e.g. within one of the area symbols, on predetermined positions within the area symbols, on the edge of an area symbol, or the like. Upon activation of the action symbol a control signal is generated including an identification of the action symbol and an identification of the area symbol the action symbol is being related to.

Other examples of receiving a user command include detecting a clicking on an action symbol by a pointing device and a subsequent clicking on one of the area symbols, thereby relating the action symbol with the area symbol.

The term input means comprises any circuit or device for receiving a user command indicative of a placement of an action symbol in relation to an area symbol. Examples of input devices include pointing devices, such as a computer mouse, a track ball, a touch pad, a touch screen, or the like. The term input means may further comprise other forms of man-machine interfaces, such as a voice interface, or the like.

The term instructions may comprise any control instructions causing the robot to perform a corresponding action. The instructions may comprise low-level instructions, directly causing specific motors, actuators, lights, sound generators, or the like to be activated. In one embodiment, the instructions include higher level instructions, such as “move forward for 3 seconds”, “turn right for 20 degrees”, etc., which are processed by the robot and translated into a corresponding plurality of low-level instructions, thereby making the instructions sent to the robot independent upon the specific features of the robot, i.e. the type of motors, gears, etc.

In a preferred embodiment, the step of generating an instruction comprises the step of generating instructions for a state machine executed by the robot.

Preferably, the at least one selected target object corresponds to a first state of the state machine.

In another preferred embodiment the method further comprises generating a download signal including the generated instruction and communicating the download signal to the toy robot. The download signal may be transferred to the robot via any suitable communications link, e.g. a wired connection, such as a serial connection, or via a wireless connection, such as an infrared connection, e.g. an IrDa connection, a radio connection, such as a Bluetooth connection, etc.

It is noted that the features of the methods described above and in the following may be implemented in software and carried out in a data processing system or other processing means caused by the execution of computer-executable instructions. The instructions may be program code means loaded in a memory, such as a RAM, from a storage medium or from another computer via a computer network. Alternatively, the described features may be implemented by hardwired circuitry instead of software or in combination with software.

Furthermore, the present invention can be implemented in different ways including the method described above and in the following, a robot, and further product means, each yielding one or more of the benefits and advantages described in connection with the first-mentioned method, and each having one or more preferred embodiments corresponding to the preferred embodiments described in connection with the first-mentioned method and disclosed in the dependant claims.

The invention further relates to a system for controlling a robot, the robot including detection means for detecting an object in a first one of a number of predetermined zones relative to the robot and for generating a detection signal identifying the first zone; and processing means for selecting and performing a predetermined action from a number of actions in response to said detection signal, the predetermined action corresponding to said first zone;

characterised in that the system comprises

means for generating a graphical user interface on a display screen, the graphical user interface having a number of area symbols each representing a corresponding one of the number of zones relative to the robot, and a plurality of action symbols, each action symbol representing at least one respective action of the robot;

input means adapted to receive a user command indicating a placement of an action symbol corresponding to a first action in a predetermined relation to a first one of said area symbols corresponding to a first zone; and

a processing unit adapted to generate an instruction for controlling the toy robot to perform the first action in response to detecting an object in the first zone.

The invention further relates to a robot comprising

detection means for detecting an object in a first one of a number of predetermined zones relative to the robot and for generating a detection signal identifying the first zone;

processing means for selecting and performing a predetermined action from a number of actions in response to said detection signal, the predetermined action corresponding to said first zone;

characterised in that the detection means is further adapted to identify the object as a first one of a number of predetermined target objects and to generate a corresponding identification signal;

the processing means is adapted to receive the detection and identification signals and to select and perform at least one of a number of actions depending on the identified first target object and on said detection signal identifying the first zone where the identified first target object is detected in.

In a preferred embodiment, the processing means is adapted to implement a state machine

including a number of states each of which corresponds to one of a number of predetermined target object selection criteria;

a first selection module for selecting a first one of the number of states of the state machine in response to said identification signal; and

a second selection module for selecting one of a number of actions depending on the selected first state and depending on said detection signal identifying the first zone where the identified target object is detected in. Hence, the states of the state machine implement context-dependant behaviour, where each state is related to one or more target objects as specified by a selection criterion. In one embodiment, a selection criterion is a specification of a type of target object, such as any robot, any robot controlling device, my robot controlling device, any robot of the opposite team, etc. Alternatively or additionally, a selection criterion may comprise a robot/object identifier, a list or range of robot/object identifiers, etc.

The invention further relates to a toy set comprising a robot described above and in the following.

The invention further relates to a toy building set comprising a toy unit comprising a robot described above and in the following wherein the toy unit comprises coupling means for inter-connecting with complementary coupling means on toy building elements.

### BRIEF DESCRIPTION OF THE DRAWINGS

The invention will be explained more fully below in connection with a preferred embodiment and with reference to the drawing, in which:

FIG. 1a shows a top-view of two robots and their spatial interrelationship;

FIG. 1b shows a top-view of a robot and zones defined by spatial irradiance characteristics of emitted signals;

FIG. 1c shows a top-view of a robot and zones defined by spatial sensitivity characteristics of received signals;

FIG. 1d shows a top-view of two robots each being in one of the others irradiance/sensitivity zone;

FIG. 1e shows a top-view of a robot and zones defined by spatially irradiance characteristics of signals emitted at different power levels;

FIG. 2 shows a toy robot with emitters emitting signals that are characteristic for each one of a number of zones that surround the robot;

FIG. 3a shows the power levels used for transmitting ping-signals by a robot at three different power levels;

FIGS. 3b-e show the power levels for transmitting ping-signals by different diode emitters of a robot.

FIG. 4 shows a block diagram for transmitting ping-signals and messages;

FIG. 5 shows sensitivity curves for two receivers mounted on a robot;

FIG. 6 shows a device with an emitter emitting signals that are characteristic for each one of a number of zones that surround the device;

FIG. 7 shows a block-diagram for a system for receiving ping-signals and message signals;

FIG. 8 shows a block-diagram for a robot control system;

FIG. 9 shows a state event diagram of a state machine implemented by a robot control system;

FIG. 10 shows a schematic view of a system for programming a robot;

FIG. 11 shows a schematic view of an example of a graphical user interface for programming a robot;

FIG. 12 shows a schematic view of a graphical user interface for editing action symbols; and

FIG. 13 shows a schematic view of another example of a graphical user interface for programming a robot.

### DETAILED DESCRIPTION OF PREFERRED EMBODIMENTS

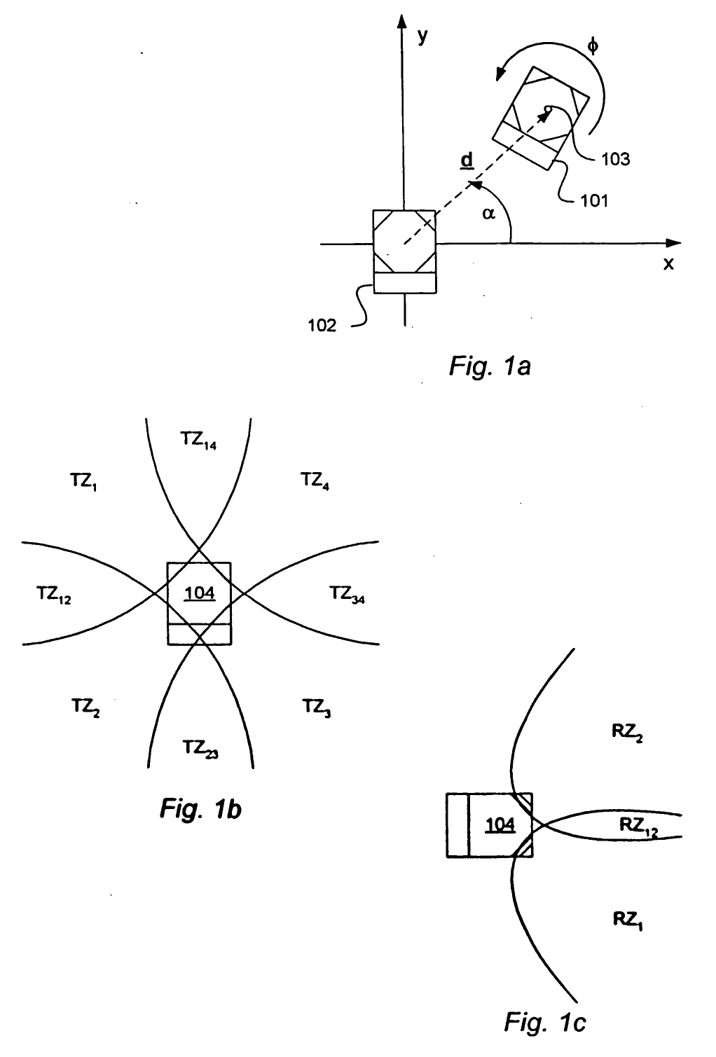

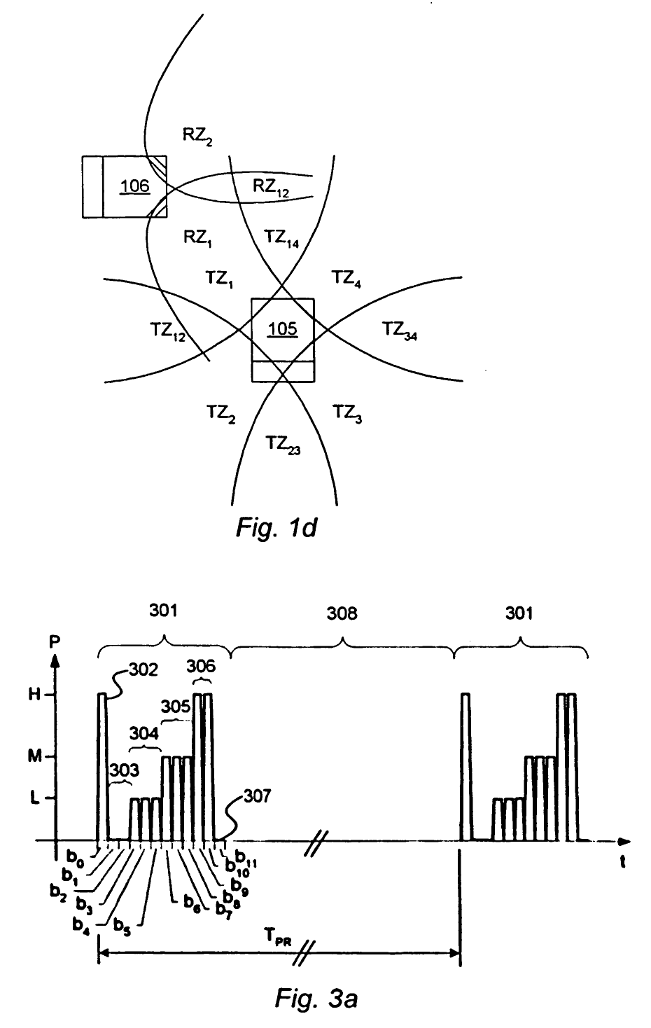

FIG. 1a shows a top-view of a first robot and a second robot, wherein the relative position, distance, and orientation of the two robots are indicated. In order to describe this spatial relationship between the two robots, the second robot 102 is positioned in the origin of a system of coordinates with axes x and y. The first robot 101 is positioned a distance d away from the second robot 102 in a direction a relative to the orientation of the second robot. The orientation (i.e. an angular rotation about a vertical axis 103) of the first robot relative to the second robot can be measured as φ.

If knowledge of d, α, and φ is available in the second robot 102 it is possible for the second robot 102 to navigate in response to the first robot 101. This knowledge can be used, as input to a system that implements a type of inter-robot behaviour. The knowledge of d, α, and φ can be maintained by a robot position system. d, α, and φ can be provided as discrete signals indicative of respective types of intervals i.e. distance or angular intervals.

According to the invention and as will be described more fully below, the knowledge of d, α, or φ is obtained by emitting signals into respective confined fields around the first robot where the respective signals carry spatial field identification information. The second robot is capable of determining d, α, and/or φ when related values of the spatial field identification information and respective fields can be looked up.

The emitted signals can be in the form of infrared light signals, visible light signals, ultra sound signals, radio frequency signals etc.

It should be noted that the above-mentioned fields are denoted zones in the following.

FIG. 1b shows a top-view of a robot and zones defined by spatial irradiance characteristics of emitted signals. The robot 104 is able to transmit signals TZ₁, TZ₁₂, TZ₂, TZ₂₃, TZ₃, TZ₃₄, TZ₄ and TZ₁₄ into respective zones that are defined by the irradiance characteristics of four emitters (not shown). The emitters are arranged with a mutual distance and at mutually offset angles to establish mutually overlapping irradiance zones around the robot 104. When the signals TZ₁, TZ₁₂, TZ₂, TZ₂₃, TZ₃, TZ₃₄, TZ₄ and TZ₁₄ can be identified uniquely from each other and when a signal can be received it is possible to deduce in which of the zones the signal is received. This will be explained in more detail.

FIG. 1c shows a top-view of a robot and zones defined by spatial sensitivity characteristics of received signals. The robot 104 is also able to receive signals RZ₁, RZ₁₂, and RZ₂ typically of the type described above. The receivers are also arranged with a mutual distance and at mutually offset angles to establish mutually overlapping reception zones around the robot 104. With knowledge of the position of the reception zone of a corresponding receiver or corresponding receivers the direction from which the signal is received can be determined. This will be explained in more detail also.

FIG. 1d shows a top-view of two robots each being in one of the others irradiance/sensitivity zone. The robot 106 receives a signal with a front-right receiver establishing reception zone RZ₁. Thereby the direction of a robot 105 can be deduced to be in a front-right direction. Moreover, the orientation of the robot 105 can be deduced in the robot 106 if the signal TZ₁ is identified and mapped to the location of a spatial zone relative to the robot 105. Consequently, both the direction to the robot 105 and the orientation of the robot 105 can be deduced in the robot 106. To this end the robot 105 must emit signals of the above mentioned type whereas the robot 106 must be able to receive the signals and have information of the irradiance zones of the robot 105. Typically, both the transmitting and receiving system will be embodied in single robot.

FIG. 1e shows a top-view of a robot and zones defined by spatially irradiance characteristics of signals emitted at different power levels. The robot 107 is able to emit zone-specific signals as illustrated in FIG. 1b with the addition that the zone-specific signals are emitted at different power levels. At each power level the signals comprise information for identifying the power level. The robot 107 thereby emits signals with information specific for a zone (Z₁, Z₂, . . . ) and a distance interval from the robot 107. A distance interval is defined by the space between two irradiance curves e g. (Z1;P2) to (Z1;P3).

If a robot 108 can detect information identifying zone Z₁ and identifying power level P₄ but not power levels P₃, P₂ and P₁, then it can be deduced by robot 108 that it is present in the space between (Z₁;P₄) and (Z₁;P₃). The actual size of the distance between the curves (e.g. (Z₁;P₄) and (Z₁;P₃)) is determined by the sensitivity of a receiver for receiving the signals and the power levels at which the signals are emitted.

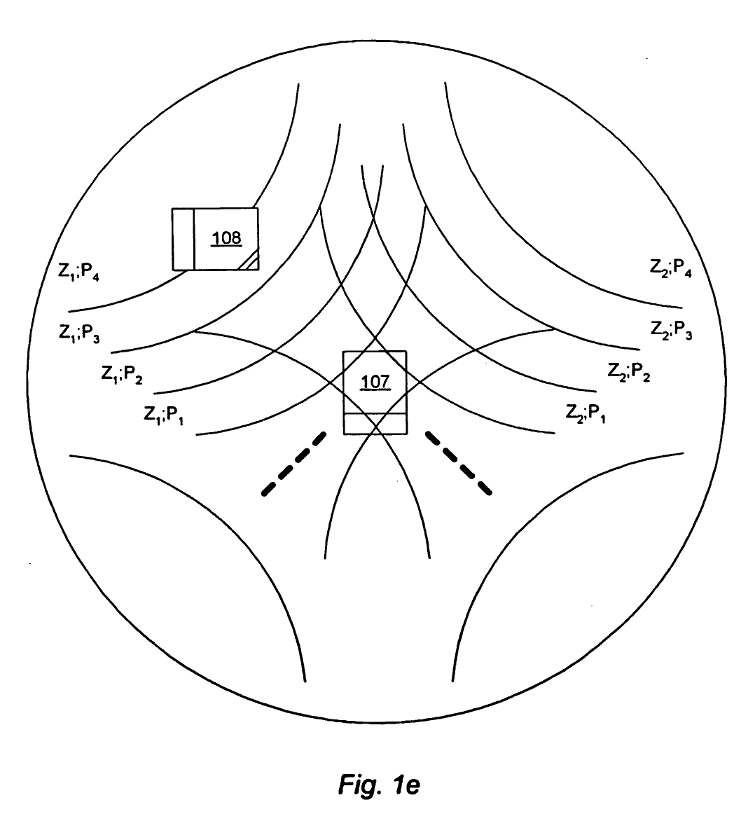

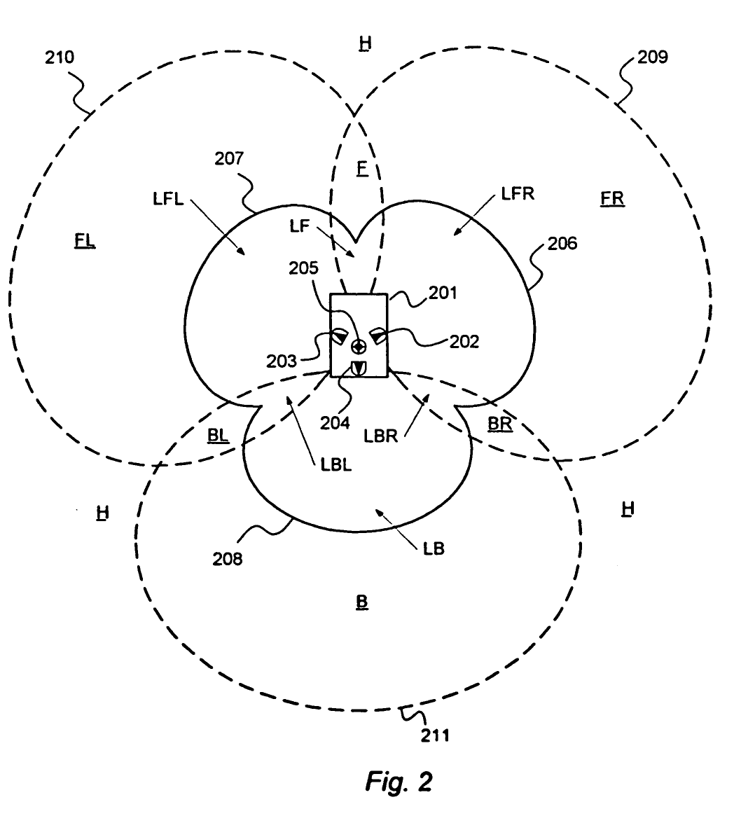

FIG. 2 shows a toy robot with emitters emitting signals that are characteristic for each one of a number of zones that surround the robot. The robot 201 is shown with an orientation where the front of the robot is facing upwards.

The robot 201 comprises four infrared light emitters 202, 203, 204, and 205, each emitting a respective infrared light signal. Preferably, the emitters are arranged to emit light at a wavelength between 940 nm and 960 nm.

The infrared light emitters 202, 203, and 204 are mounted on the robot at different positions and at different angles to emit infrared light into zones FR, FL, and B as indicated by irradiance curves 209, 210, and 211, respectively, surrounding the robot. The directions of these diodes are 60°, 300°, and 180°, respectively, with respect to the direction of forward motion of the robot. When the angle of irradiance of each of the diodes is larger than 120°, e.g. between 120° and 160°, the zones 209 and 210 overlap to establish a further zone F; similarly the zones 210 and 211 overlap to establish a zone BL, and zones 209 and 211 overlap to establish zone BR. The zones are defined by the radiation aperture and the above-mentioned position and angle of the individual emitters—and the power of infrared light emitted by the emitters.

The emitters 202, 203, and 204 are controlled to emit infrared light at two different power levels; in the following these two power levels will be referred to as a low power level (prefix ‘L’) and a medium power level (prefix ‘M’).

The relatively large irradiance curves 209, 210, and 211 represent zones within which a receiver is capable of detecting infrared light signals FR, FL and B emitted towards the receiver when one of the transmitters is transmitting at a medium power level. Likewise, the relatively small irradiance curves 206, 207, and 208 represent zones within which a receiver is capable of detecting infrared light signals LFR, LFL and LB emitted towards the receiver when one of the transmitters is transmitting at a low power level. In one embodiment, the relatively large curves 209, 210, 211 have a diameter of about 120-160 cm. The relatively small curves 206, 207, and 208 have a diameter of about 30-40 cm.

The emitter 205 is arranged to emit a signal at a high power level larger than the above medium power level to the surroundings of the robot. Since this signal is likely to be reflected from objects such as walls, doors etc., a corresponding irradiance curve is not shown—instead a capital H indicates this irradiance. High-power ping-signals should be detectable in a typical living room of about 6×6 metres.

Thus, the emitters 202, 203, and 204 are arranged such that when operated at a medium power level (M), they establish mutual partly overlapping zones 209, 210, and 211. Additionally, when the emitters 202, 203, and 204 are operated at a low power level (L), they establish mutual partly overlapping zones 206, 207, and 208. This allows for an accurate determination of the orientation of the robot 201.

In the embodiment of FIG. 2, the overlap zones LF, LBR, and LBL are defined by a receiver being in the corresponding overlapping zone at medium power level, i.e. F, BR, and BL, respectively, and receiving a low power signal from at least one of the diode emitters 202, 203, and 204.

Each of the infrared signals FR, FL, and B are encoded with information corresponding to a unique one of the infrared emitters thereby corresponding to respective zones of the zones surrounding the robot.

The infrared signals are preferably arranged as time-multiplexed signals wherein the information unique for the infrared emitters is arranged in mutually non-overlapping time slots.

In order to be able to determine, based on the signals, in which of the zones a detector is present a detector system is provided with information of the relation between zone location and a respective signal.

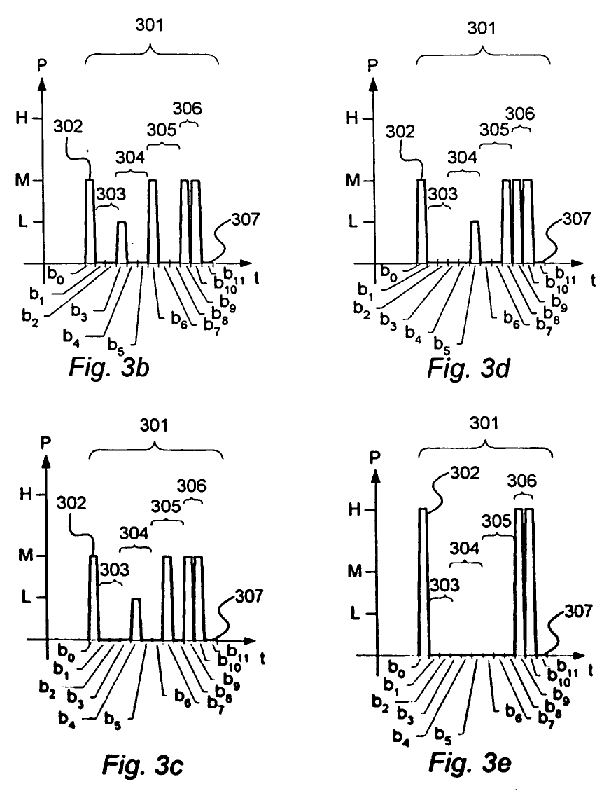

A preferred embodiment of a detection principle will be described in connection with FIGS. 3a-e.

In order for a transmitting robot to encode orientation and distance information and to transmit the information into the zones for subsequent decoding and interpretation in another receiving robot, a network protocol is used. The network protocol is based on ping-signals and message signals. These signals will be described in the following.

FIG. 3a shows the power levels used for transmitting ping-signals from the respective emitters, e.g. the emitters 202, 203, 204, and 205 of FIG. 2. The power levels P are shown as a function of time t at discrete power levels L, M and H.

The ping signals are encoded as a position information bit sequence 301 transmitted in a tight sequence. The sequence 301 is transmitted in a cycle with a cycle time TPR, leaving a pause 308 between the tight sequences 301. This pause is used to transmit additional messages and to allow other robots to transmit similar signals and/or for transmitting other information—e.g. message signals.

A position information bit sequence 301 comprises twelve bits (b0-b11), a bit being transmitted at low power (L), medium power (M), or at high power (H). The first bit 302 is transmitted by diode 205 at high power. In a preferred embodiment, this bit is also transmitted by the emitters 202, 203, and 204 at medium power. By duplicating the high power bit on the other diodes with medium power, the range of reception is increased and it is ensured that a nearby receiver receives the bit even if the walls and ceiling of the room are poor reflectors. The initial bit is followed by two bits 303 of silence where non of the diodes transmit a signal. The subsequent three bits 304 are transmitted at low power level, such that each bit is transmitted by one of the diodes 202, 203, and 204 only. Similarly, the following three bits 305 are transmitted at medium power level such that each of the diodes 202, 203, and 204 transmits only one of the bits 305. The subsequent two bits 306 are again transmitted by the diode 205 at high power level and, preferably, by the diodes 202, 203, and 204 at medium power level, followed by a stop bit of silence 307.

Hence, each of the diodes 202, 203, 204, and 205 transmits a different bit pattern as illustrated in FIGS. 3b-e, where FIG. 3b illustrates the position bit sequence emitted by diode 202, FIG. 3c illustrates the position bit sequence emitted by diode 203, FIG. 3d illustrates the position bit sequence emitted by diode 204, and FIG. 3e illustrates the position bit sequence emitted by diode 205.

A receiving robot can use the received bit sequence to determine the distance to the robot which has transmitted the received bit pattern and the orientation of the transmitting robot, since the receiving robot can determine which one of the zones of the transmitting robot the receiving robot is located in. This determination may simply be performed by means of a look-up table relating the received bit pattern to one of the zones in FIG. 2. This is illustrated by table 1.

TABLE 1

| Received position bit sequence | Zone |
|---|---|
| no signal | no robot present |
| 100000000110 | H |
| 100000100110 | FR |
| 100000010110 | FL |
| 100000001110 | B |
| 100000110110 | F |
| 100000101110 | BR |
| 100000011110 | BL |
| 100100100110 | LFR |
| 100010010110 | LFL |
| 100001001110 | LB |
| 100100110110, 100010110110, or 100110110110 | LF |
| 100100101110, 100001101110, or 100101101110 | LBR |
| 100010011110, 100001011110, or 100011011110 | LBL |

Table 1 shows how the encoded power level information in transmitted ping-signals can be decoded into presence, if any, in one of the zones of the transmitting robot. A zone is in turn representative of an orientation and a distance.

It is understood that the above principle may be applied to a different number of diodes and/or a different number of power levels, where a higher number of diodes increases the accuracy of the determination of orientation and higher number of power levels increases the accuracy of the distance measurement. This increase in accuracy is achieved at the cost of increasing the bit sequence and, thus, decreasing the transmission rate.

In one embodiment, the robot transmits additional messages, e.g. Fin connection with a ping signal or as a separate message signal. Preferably, the messages are transmitted in connection with a position information bit sequence, e.g. by transmitting a number of bytes after each position bit sequence. In one embodiment, the robot transmits a ping signal comprising a position information bit sequence followed by header byte, a robot ID, and a checksum, e.g. a cyclic redundancy check (CRC). Additionally or alternatively other information may be transmitted, such as further information about the robot, e.g. speed, direction of motion, actions, etc., commands, digital tokens to be exchanged between robots, etc.

Each byte may comprise a number of data bits, e.g. 8 data bits, and additional bits, such as a start bit, a stop bit, and a parity bit. The bits may be transmitted at a suitable bit rate, e.g. 4800 baud. Preferably, the additional message bytes are transmitted at high power level by diode 205 and at medium power level by the diodes 202, 203, and 204.

Preferably, the robot ID is a number which is unique to the robot in a given context. The robot ID enables robots to register and maintain information on fellow robots either met in the real world or over the Internet. The robot may store the information about other robots as part of an external state record, preferably as a list of known robots. Each entry of that list may contain information such as the robot ID, mapping information, e.g. direction, distance, orientation, as measured by the sensors of the robot, motion information, game related information received from the respective robot, e.g. an assignment to a certain team of robots, type information to be used to distinguish different groups of robots by selection criteria, an identification of a robot controller controlling the robot, etc.

When a robot receives a broadcast message from another robot, it updates information in the list. If the message originator is unknown, a new entry is made. When no messages have been received from a particular entry in the list for a predetermined time, e.g. longer than two broadcast repetitions, a robot entry is marked as not present.

In order to keep the robot ID short, e.g. limit it to one byte, and allow a unique identification of a robot in a given context, an arbitration algorithm may be used among the robots present inside a communication range, e.g. within a room For example, a robot receiving a ping signal from another robot with the same ID may select a different ID.

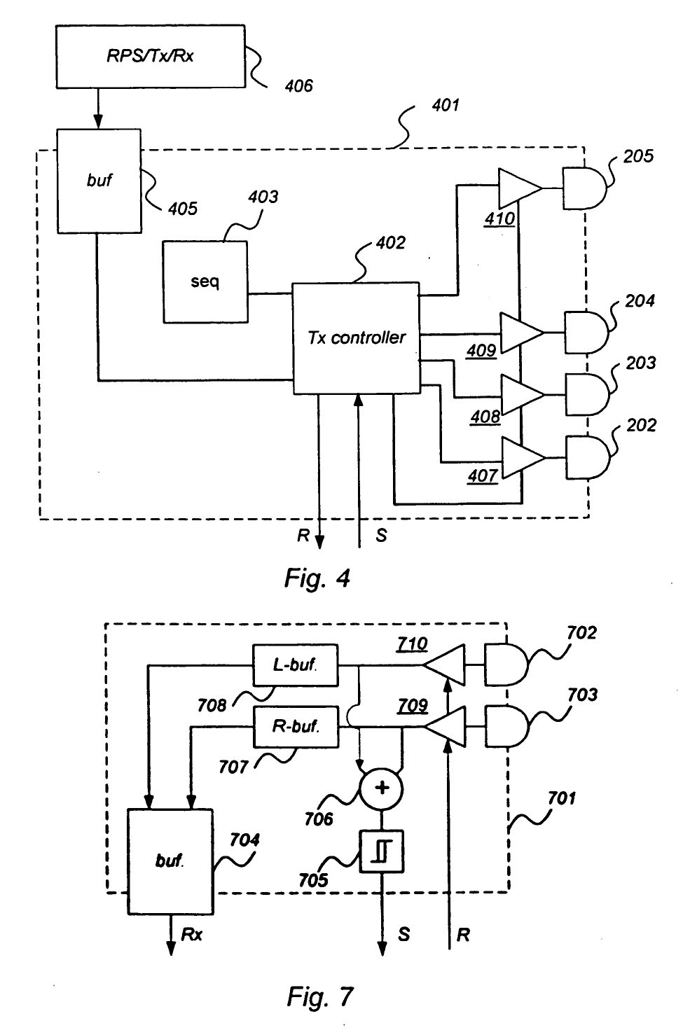

FIG. 4 shows a block diagram of a communications system for transmitting ping-signals and message-signals. The system 401 receives ping-signals (e.g. the header, robot ID and CRC bytes) and message signals via a buffer 405. The ping- and message-signals are provided by an external system (not shown) via a transmission interface 406. The communications system 401 is thus able to receive information from the external system, which in turn can be operated asynchronously of the communications system.

The system comprises a memory 403 for storing the respective position bit sequences for the different diodes as described in connection with FIGS. 3a-e.

A controller 402 is arranged to receive the ping- and message-signals, prefix the corresponding bit sequences retrieved from the memory 403 and control the infrared light transmitters 202, 203, 204, and 205 via amplifiers 407, 408, 409, and 410. The power levels emitted by the emitters 202, 203, 204 and 205 are controlled by adjusting the amplification of the amplifiers 407, 408, 409 and 410. The signal S provided to the controller is a binary signal indicative of whether there is communication silence that is, no other signals that possibly might interfere with signals to be emitted are detectable. The controller further provides a signal R indicating when a signal is transmitted.

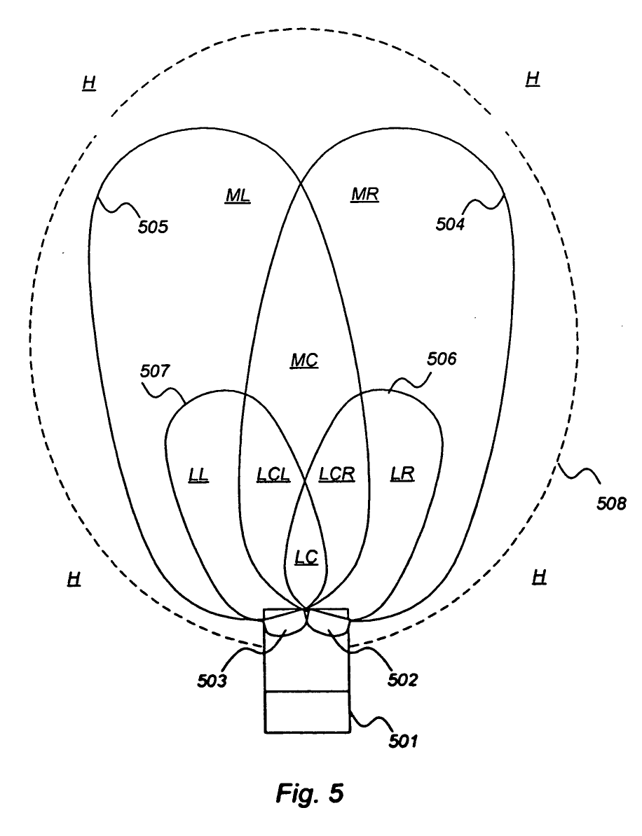

FIG. 5 shows sensitivity curves for two receivers mounted on a robot. The curve 504 defines the zone in which a signal at medium power-level as described in connection with FIG. 2 and transmitted towards the receiver 502 can be detected by the receiver 502. The curve 506 defines a smaller zone in which a signal transmitted towards the receiver 502 at low power level can be detected by the receiver 502.

The curves 505 and 507 define zones in which a signal transmitted towards the receiver 503 at medium and low power level, respectively, can be detected by the receiver 503. Generally, the above-mentioned zones are denoted reception zones. A zone in which a signal transmitted towards one of the receivers 502 and 503 at high power can be detected is more diffuse; therefore such a zone is illustrated with the dotted curve 508.

Since the emitters 202. 203, 204 in FIG. 2 transmit signals with information representative of the power level at which the signals are transmitted, the direction and distance to the position at which another robot appears can be determined in terms of the zones H, ML MC, MR, LL, LCL, LC, LCR and LR. One or both of the two receivers 502 and 503 on a first robot can receive the signals emitted by the emitters 202, 203, 204, and 205 of a second robot.

Consequently, a fine resolution of distance, direction and orientation can be obtained with a simple transmitting/receiving system as described above.

In the following it is more fully described how to decode direction and distance information. It is assumed that:

if one receiver gets high power ping-signals, so does the other;

if a receiver gets low power ping-signals, it also gets medium and high power pings;

if a receiver gets medium power ping-signals, it also gets high power ping-signals.

Applying the notation: L for low power ping-signals, M for medium power ping-signals, and H for high power ping signals; a zone of presence can be determined based on received signals according to table 2 below.

TABLE 2

| left receiver (503) | right receiver (502) | Zone |
|---|---|---|
| no signal | no signal | no robot present |
| H | H | H |
| H-M | H | ML |
| H-M | H-M | MC |
| H | H-M | MR |
| H-M-L | H | LL |
| H-M-L | H-M | LCL |
| H-M-L | H-M-L | LC |
| H-M | H-M-L | LCR |
| H | H-M-L | LR |

Table 2 shows how the encoded power level information in transmitted ping-signals can be decoded into presence, if any, in one of the ten zones in the left column. A zone is in turn representative of a direction and a distance.

For the purpose of decoding orientation information table 1 above can be used.

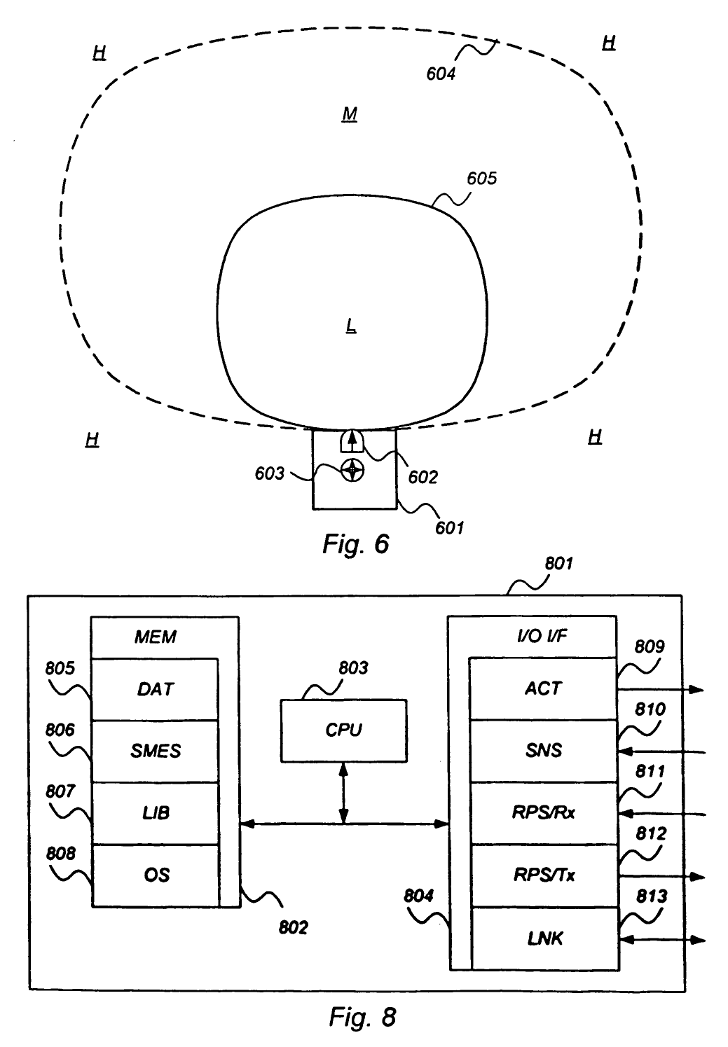

FIG. 6 shows a device with an emitter emitting signals that are characteristic for each one of a number of zones that surround the device. Similar to the robot of FIG. 2, the device 601 comprises infrared light emitters 602 and 603, each emitting a respective infrared light signal. Preferably, the emitters are arranged to emit light at a wavelength between 940 nm and 960 nm. However, the device 601 only comprises one infrared light emitter 602 mounted on the device to emit infrared light into zones M and L at medium and low power levels and as indicated by irradiance curves 604 and 605, respectively.

The emitter 603 is arranged to emit a signal at a high power level larger than the above medium power level to the surroundings of the device, as described in connection with emitter 205 in FIG. 2.

Thus, the emitters 602 and 603 are arranged to establish three proximity zones, A zone L proximal to the device, a zone M of medium distance and an outer zone H, thereby allowing for a distance measurement by another device or robot.

The diode 602 and 603 are controlled to emit ping signals comprising a position bit sequence as described in connection with FIGS. 3a-e. The bit pattern transmitted by diode 603 corresponds to the bit pattern of the high power diode 205 of the embodiment of FIG. 2. i.e. the bit pattern shown in FIG. 3e. The bit pattern transmitted by diode 603 corresponds to the bit pattern of FIG. 3c.

A receiving robot can use the received bit sequence to determine the distance to the robot which has transmitted the received bit pattern as described in connection with FIGS. 3a-e above.

The device 601 may be a robot or a stationary device for communicating with robots, e.g. a remote control, robot controller, or another device adapted to transmit command messages to a robot.

Hence, a robot may be controlled by sending command messages from a remote control or robot controller where the command messages comprise distance and/or position information, thereby allowing the robot to interpret the received commands depending on the distance to the source of the command and/or the position of the source of the command.

FIG. 7 shows a block-diagram of a system for receiving ping-signals and message-signals. The system 701 comprises two infrared receivers 702 and 703 for receiving inter-robot signals (especially ping-signals and message-signals) and remote control signals.

Signals detected by the receivers 702 and 703 are provided as digital data by means of data acquisition means 710 and 709 in response to arrival of the signals, respectively. The digital data from the data acquisition means are buffered in a respective first-in-first-out buffer, L-buffer 708 and R-buffer 707. Data from the L-buffer and R-buffer are moved to a buffer 704 with a larger capacity for accommodating data during transfer to a control system (not shown).

The binary signal S indicative of whether infrared signals are emitted towards the receivers 702 and 703 is provided via a Schmitt-trigger 705 by an adder 706 adding the signals from the data acquisition means 709 and 710. Thereby the signal is indicative of whether communication silence is present.

The control signal R indicates when the robot itself is transmitting ping signals and it is used to control the data acquisition means 710 and 709 to only output a data signal when the robot is not transmitting a ping signal. Hence, the reception of a reflection of the robot's own ping signal is avoided.

The system can be controlled to receive signals from a remote control unit (not shown). In that case, the data supplied to the buffer is interpreted as remote control commands. Thereby, the receivers 702 and 703 may be used for receiving ping-/message-signals as well as remote control commands.

FIG. 8 shows a block-diagram of a robot control system. The control system 801 is arranged to control a robot that may be programmed by a user to exhibit some type of behaviour. The control system 801 comprises a central processing unit (CPU) 803, a memory 802 and an input/output interface 804.

The input/output interface 804 comprises an interface (RPS/Rx) 811 for receiving robot position information, an interface (RPS/Tx) 812 for emitting robot position information, an action interface 809 for providing control signals to manoeuvring means (not shown), a sensing interface 810 for sensing different physical influences via transducers (not shown), and a link interface 813 for communicating with external devices.

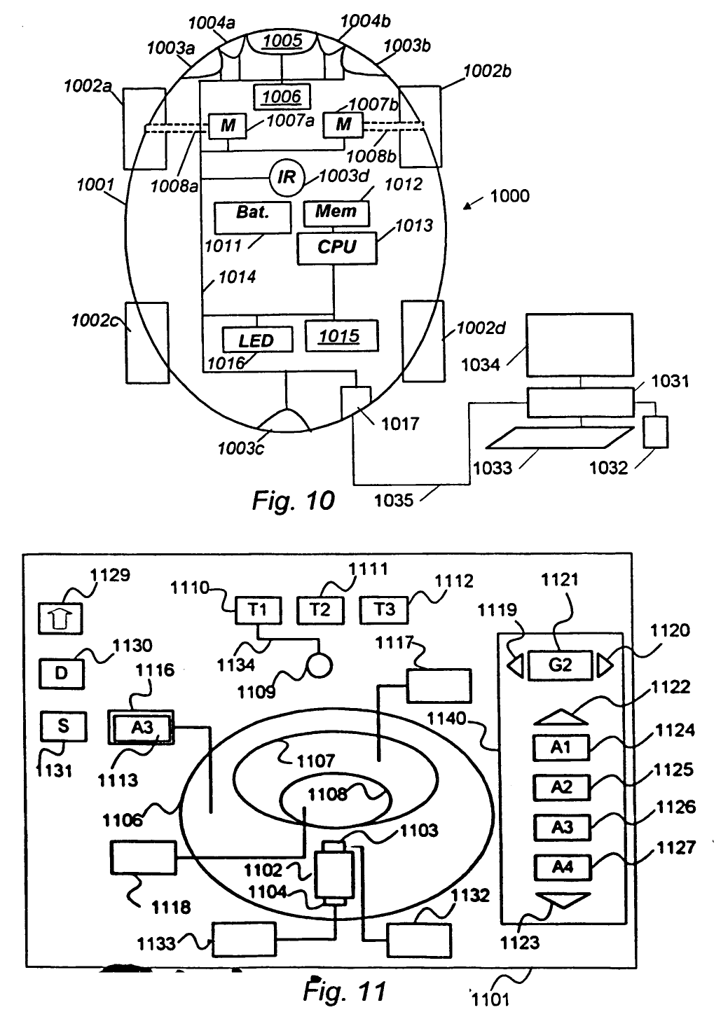

Preferably, the interface RPS/Rx 811 may be embodied as shown in FIG. 4; and the interface RPS/Tx is embodied as shown in FIG. 7. The link interface 813 is employed to allow communication with external devices e.g. a personal computer, a PDA, or other types of electronic data sources/data consumer devices, e.g. as described in connection with FIG. 10. This communication can involve program download/upload of user created script programs and/or firmware programs. The interface can be of any interface type comprising electrical wire/connector types (e.g. RS323); IR types (e.g. IrDa); radio frequency types (e.g. Blue tooth); etc.

The action interface 809 for providing control signals to manoeuvring means (not shown) is implemented as a combination of digital output ports and digital-to-analogue converters. These ports are used to control motors, lamps, sound generators, and other actuators.

The sensing interface 810 for sensing different physical influences is implemented as a combination of digital input ports and analogue-to-digital converters. These input ports are used to sense activation of switches and/or light levels, degrees of temperature, sound pressure, or the like.

The memory 802 is divided into a data segment 805 (DATA), a first code segment 806 (SMES) with a state machine execution system, a second code segment 807 with a functions library, and a third code segment 808 with an operating system (OS).

The data segment 805 is used to exchange data with the input/output interface 804 (e.g. data provided by the buffer 704 and data supplied to the buffer 405). Moreover, the data segment is used to store data related to executing programs.

The second code segment 807 comprises program means that handle the details of using the interface means 804. The program means are implemented as functions and procedures which are executed by means of a so-called Application Programming Interface (API).

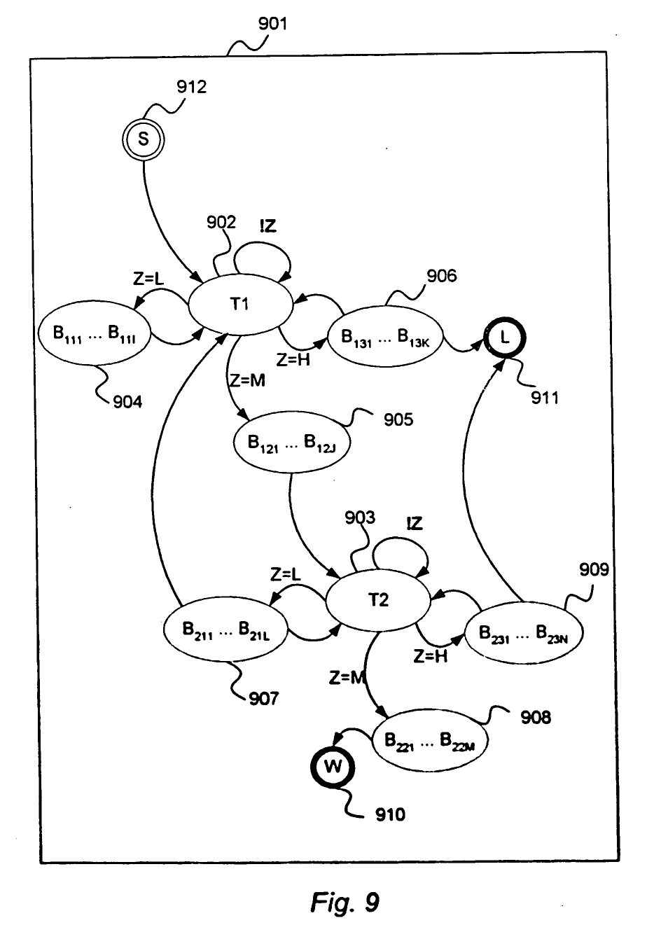

The first code segment 806 comprises program means implementing a programmed behaviour of the robot. Such a program is based on the functions and procedures provided by means of the Application Programming Interface. An example of such a program implementing a state machine will be described in connection with FIG. 9.

The third code segment 808 comprises program means for implementing an Operating System (OS) that handles multiple concurrent program processes, memory management etc.

The CPU is arranged to execute instructions stored in the memory to read data from the interface and to supply data to the interface in order to control the robot and/or communicate with external devices.

FIG. 9 shows a state event diagram of a state machine implemented by a robot control system. The state machine 901 comprises a number of goal-oriented behaviour states 902 and 903, one of which may be active at a time. In the example of FIG. 9, the state machine comprises two behaviour states 902 and 903. However, this number is dependant on the actual game scenario and may vary depending on the number of different goals to be represented. Each of the behaviour states is related to a number of high-level actions: In the example of FIG. 9, state 902 is related to actions B₁₁₁, . . . , B_{11I}, B₁₂₁, . . . , B_{12J}, B₁₃₁, . . . , B_{13K}, i.e. (I+J+K) actions, while state 903 is related to actions B₂₁₁, . . . , B_{21L}, B₂₂₁, . . . , B_{22M}, B₂₃₁, . . . , B_{23N,} i.e. (L+M+N) actions. Preferably, the actions include instructions to perform high-level goal-oriented behaviour. Examples of such actions include “Follow robot X”, “Run away from robot Y”, “Hit robot Z”, “Explore the room”, etc. These high-level instructions may be implemented via a library of functions which are translated into control signals for controlling the robot by the control unit of the robot, preferably in response to sensor inputs. The above high-level actions will also be referred to as action beads. There may be a number of different type of action beads, such as beads performing a state transition from one state of the state diagram to another state, conditional action beads which perform an action if a certain condition is fulfilled, etc. In one embodiment, a condition may be tested by a watcher process executed by the robot control system. The watcher process may monitor the internal or external state parameters of the robot and send a signal to the state machine indicating when the condition is fulfilled. For example, a watcher may test whether a robot is detected in a given reception zone, whether a detected robot has a given orientation, etc. Hence, in one embodiment, an action bead may comprise one or more of a set of primitive actions, a condition followed by one or more primitive actions, or a transition action which causes the state machine execution system to perform a transition into a different state. It is noted that, alternatively or additionally, state transitions may be implement by a mechanism other than action beads.

It is an advantage of such a state machine system that all goals, rules, and strategies of a game scenario are made explicit and are, thus, easily adjustable to a different game scenario.

The state diagram of FIG. 9 comprises a start state 912, a win state 910, a lose state 911, and two behaviour states 902 and 903, each of the behaviour states representing a target object T1 and T2, respectively. A target object is identified by a selection criterion, e.g. a robot ID of another robot or device, a specification of a number of possible robots and/or devices, such as all robots of a certain type, any other robot, any robot of another team of robots, the robot controller associated with the current robot, or the like.

Each of the behaviour states is related to three action states representing respective proximity zones. State 902 is related to action states 904, 905, 906, where action state 904 is related to proximity zone L, action state 905 is related to proximity zone M, and action state 906 is related to proximity zone H. Hence, in state 902, the state machine execution system tests, if a target object T1 fulfilling the selection criterion of state 902 has been detected in any of the zones.

Depending on the selection criterion there may be more than one target objects fulfilling the selection criterion which are detected within the proximity zones of the robot. The state machine execution system may identify the detected target robots by searching a list of all currently detected objects maintained by the robot and filtering the list using the selection criterion of the current state. If more than one objects fulfil the selection criterion, a predetermined priority rule may be applied for selecting one of the detected objects as the current target object T1. In one embodiment, zone information may be used to select the target object among the objects fulfilling the selection criterion. For example, objects having a shorter distance to the robot may be selected with a higher priority.

If the target object T1 of state 902 is detected in proximity zone L, the system continues execution in action state 904. Action state 904 includes a number of action beads B₁₁₁, . . . , B_{11I} which are executed, e.g. sequentially, possibly depending on certain conditions, if one or more of the action beads are conditional action beads. When the actions B₁₁₁, . . . , B_{11I} are executed, the state machine continues execution in state 902. If action state 904 does not contain any action beads, no actions are performed and the state machine execution system returns to state 902. Similarly, if the target object is detected in zone M, execution continues in state 905 resulting in execution of beads B₁₂₁, . . . , B_{12 j}. In the example of FIG. 9, it is assumed that action bead B_{12J} is a transition action causing transition to state 903. Hence, in this case execution is continued in state 903. If, while in state 902, the target object is detected in zone H, execution continues in state 905 resulting in execution of beads B₁₃₁, . . . , B_{13K}. In the example of FIG. 9, it is assumed that action bead B_{13K} is a transition action causing transition to the lose state 911 causing the game scenario to terminate. The lose state may cause the robot to stop moving and indicate the result of the game, e.g. via a light effect, sound effect, or the like. Furthermore, the robot may transmit a corresponding ping message indicating to other robots that the robot has lost. Finally, if in state 902, the target object is not detected in any zone, execution continues in state 902. Alternatively, there may be a special action state related to this case as well, allowing to perform a number of actions in this case.

Similarly, behaviour state 903 is related to target T2, i.e. a target object selected by the corresponding target selection criterion of state 903, as described above. Hence, when in state 903, the state machine execution system checks whether target object T2 is detected in one of the zones with prefix L, M, or H. If target object T2 is detected in zone L, execution is continued in state 907 resulting in execution of action beads B₂₁₁, . . . , B_{21L}. In the example of FIG. 99 it is assumed that one of the action beads B₂₁₁, . . . , B_{21L} is a conditional transition bead to state 902. Consequently, if the corresponding condition is fulfilled, execution is continued in state 902; otherwise the state machine execution system returns to state 903 after execution of the action beads B₂₁₁, . . . , B_{21L}. If in state 903 the target object T2 is detected to be in zone M, execution is continued in state 908 resulting in execution of action beads B₂₂₁, . . . , B_{22M}. In the example of FIG. 9, it is assumed that one of the action beads B₂₂₁, . . . , B_{22M} is a conditional transition bead to the win state 910. Consequently, if the corresponding condition is fulfilled, execution is continued in state 910; otherwise the state machine execution system returns to state 903 after execution of the action beads B₂₂₁, . . . , B_{22M}. Finally, if in state 903 the target object T2 is detected to be in zone H, execution is continued in state 909 resulting in execution of action beads B₂₃₁, . . . , B_{23N} and subsequent return to state 903.

In one embodiment, if the target object is detected to have moved from one zone to the another, the currently executing action is aborted and the state execution system returns to the corresponding behaviour state. From the behaviour state, the execution is continued in the action state corresponding to the new zone, as described above.

In the example of FIG. 9, the zones L, M, and H correspond to the proximity zones defined via the receptive zones illustrated in FIG. 5, corresponding to the three power levels L, M, and H. Hence, according to this embodiment, only the distance information is used in order to determine which action state is to be executed for a given target object. A target object is detected as being within the L zone, if it is at least within one of the reception zones 506 and 507 of FIG. 5; the target is detected to be within the M zone, if it is detected in at least one of the zones 504 and 505 but not in the L zone, and it is detected to be in the H zone, if it is detected to be with in the reception zone 508 but not in any of the other zones. However, the instructions corresponding to an action bead may also use direction information and/or orientation information.

Furthermore, it is noted that in another embodiment there may be a different set of action states related to each behaviour state, e.g. an action state for each of the zones H, ML, MR, MC, LL, LCL, LC, LCR, and LR of FIG. 5.

It is further noted that, additionally, the behaviour of the robot may be controlled by further control signals, e.g. provided by parallel state machines, such as monitors, event handlers, interrupt handlers, etc. Hence, it is understood that the above state machine is an example, and different implementations of an execution scenario of action beads may be provided.

FIG. 10 shows an embodiment of a system for programming the behaviour of a toy robot according to the invention, where the behaviour is controlled by downloading programs. The system comprises a personal computer 1031 with a screen 1034 or other display means, a keyboard 1033, and a pointing device 1032, such as a mouse, a touch pad, a track ball, or the like. On the computer, an application program is executed which allows a user to create and edit scripts, store them, compile them and download them to a toy robot 1000. The computer 1031 is connected to the toy robot 1000 via a serial connection 1035 from one of the serial ports of the computer 1031 to the serial link 1017 of the toy robot 1000. Alternatively, the connection may be wireless, such as an infrared connection or a Bluetooth connection. When program code is downloaded from the computer 1031 to the toy robot 1000, the downloaded data is routed to the memory 1012 where it is stored. In one embodiment, the link 1017 of the toy robot comprises a light sensor and an LED adapted to provide an optical interface.

The toy robot 1000 comprises a housing 1001, a set of wheels 1002a-d driven by motors 1007a and 1007b via shafts 1008a and 1008b. Alternatively or additionally, the toy robot may include different means for moving, such as legs, threads, or the like. It may also include other moveable parts, such as a propeller, arms, tools, a rotating head or the like. The toy robot further comprises a power supply 1011 providing power to the motor and the other electrical and electronic components of the toy robot. Preferably, the power supply 1011 includes standard batteries. The toy robot further comprises a central processor CPU 1013 responsible for controlling the toy robot 1000. The processor 1013 is connected to a memory 1012, which may comprise a ROM and a RAM or EPROM section (not shown). The memory 1012 may store an operating system for the central processor 1013 and firmware including low-level computer-executable instructions to be executed by the central processor 1013 for controlling the hardware of the toy robot by implementing commands such as “turn on motor”. Furthermore, the memory 1012 may store application software comprising higher level instructions to be executed by the central processor 1013 for controlling the behaviour of the toy robot. The central processor may be connected to the controllable hardware components of the toy robot by a bus system 1014, via individual control signals, or the like.

The toy robot may comprise a number of different sensors connected to the central processor 1013 via the bus system 1014. The toy robot 1000 comprises an impact sensor 1005 for detecting when it gets hit and a light sensor 1006 for measuring the light level and for detecting blinks. The toy robot further comprises four infrared (IR) transmitters 1003a-d and two IR receivers 1004a-b for detecting and mapping other robots as described above. Alternatively or additionally, the toy robot may comprise other sensors, such as a shock sensor, e.g. a weight suspended from a spring providing an output when the toy robot is hit or bumps into something, or sensors for detecting quantities including time, taste, smell, light, patterns, proximity, movement, sound, speech, vibrations, touch, pressure, magnetism, temperature, deformation, communication, or the like.

The toy robot 1000 further comprises an LED 1016 for generating light effects, for example imitating a laser gun, and a piezo element 1015 for making sound effects. Alternatively or additionally, the toy robot may comprise other active hardware components controlled by the processor 1013.

FIG. 11 shows a schematic view of an example of a graphical user interface for programming a robot. The user interface 1101 is generated by a data processing system executing a robot control computer program. The user interface is presented on a display connected to the data processing system, typically in response to a corresponding user command. The graphical user interface comprises a representation of the robot 1102 to be programmed. The robot comprises an impact sensor 1103 and a light sensor 1104.

The user interface further comprises a number of area symbols 1106, 1107, and 1108, each of which schematically illustrating the proximity zones in which the robot may detect an object, such as another robot, a control device, or the like. The area symbols are elliptic shapes of different size and extending to different distances from the robot symbol 1101. The area 1108 illustrates the detection zone in which a signal transmitted by another robot at power level L may be received. Similarly the area 1107 illustrates the reception zone of a medium power level signal transmitted by another robot or device, and area 1106 illustrates the reception zone of a high power level signal transmitted by another robot or device. The area symbols 1106, 1107, and 1108 are further connected to control elements 1116, 1117, and 1118, respectively.

The user interface further comprises a selection area 1140 for action symbols 1124, 1125, 1126, and 1127. Each action symbol corresponds to an action which may be performed by the robot as described above. The action symbols may be labelled with their corresponding action, e.g. with a graphical illustration of the effect of the corresponding action. Each action symbol is a control element which may be activated by a pointing device. A user may perform a drag-and-drop operation on any one of the action symbols and place it within any one of the control elements 1116, 1117, and 1118. FIG. 11 illustrates a situation where an action symbol 1113 is placed within control element 1116 related to the outer zone 1106. In order to increase the number of selectable action symbols, a scroll function is provided which may be activated via control elements 1122 and 1123 allowing to scroll through the list of action symbols. The list of control symbols is further divided into groups of action symbols, e.g. by ordering action symbols into groups according to the nature of their actions. Examples of groups may include “linear motion”, “rotations”, “light effect”, “sound effects”, “robot-robot interactions”, etc. The list of action symbols 1124, 1125, 1126, and 1127 contains action symbols of one of the above groups, as indicated by a corresponding group display element 1121. The user may select different groups via control elements 1119 and 1120, thereby causing different action symbols to be displayed and made selectable.

The lists of action symbols and the corresponding instructions may be pre-written and made available, e.g. on a CD or via the Internet, as a program library for a specific species of robots. The action beads may be represented by symbols, such as circles, and their shape, colour and/or labels may identify their function. Placing an action bead in a circle may for example be done by a drag-and-drop operation with the pointing device.

The user interface further comprises additional control elements 1132 and 1133 connected to the illustrations 1103 and 1104 of the impact sensor and the light sensor, respectively. Consequently, the user may drag-and-drop action symbols into these control elements as well, thereby relating actions to these sensors. In the embodiment of FIG. 9, no more than one action symbol may be placed within each of the control elements 1116, 1117, 1118, 1132, and 1133, thereby reducing the complexity of the programmable behaviour and making the task of programming and testing simpler, in particular for children. However, in other embodiments, this limitation may be removed.

The user interface 1101 further comprises control elements 1110, 1111, and 1112 representing different target objects and, thus, different behavioural states of a state machine as described in connection with FIG. 9. The control elements 1110, 1111, and 1112 may be activated by a pointing device, e.g. by clicking on one of the elements, thereby selecting that element and deselecting the others. In FIG. 11 a situation is shown where control element 1101 is selected corresponding to target object T1. The selection is illustrated by a line 1134 to a symbol 1109 illustrating a target object. Consequently a user may place different action symbols within the different zones in relation to different target objects.

The user interface further comprises further control elements 1129, 1130, 1131 which may be activated by a pointing device. Control element 1129 allows a user to navigate to other screen pictures for accessing further functionality of the robot control system. Control element 1130 is a download button which, when activated, sends a control signal to the processing unit of the data processing system causing the data processing system to generate a program script and downloading it to a robot, e.g. as described in connection with FIG. 10.

The program script may comprise a list of target objects and the related actions for the different zones as determined by the action symbols which are placed in the corresponding control elements.

The following is an example of a representation of such a program script:

[Game]

Name=Game1

NumStates=2

[State1]

TargetObject=T1

BeadsLZone={Bead1, Bead15, Bead 34}

BeadsMZone={Bead 2, Bead1, Bead54, Bead117}

BeadsHZone={}

[State2]

TargetObject=(T2, T3)

BeadsLZone={Bead21, Bead5, Bead7}

BeadsMZone={Bead3}

BeadsHZone={Bead5, Bead1}

Alternatively or additionally, the program script may represented in a different form, a different syntax, structure, etc. For example it may be compiled into a more compact form, e.g. a binary format. During compilation, the pre-defined scripts corresponding to the action beads are related to the zones where the beads are placed.

The control element 1131 is a save button which, when activated, causes the data processing system to generate the above program script and save it on a storage medium, such as a hard disk, diskette, writable CD-ROM or the like. If several programs are stored on the computer a save dialog may be presented allowing the user to browse through the stored programs.

It is understood that, alternatively or additionally, the user interface may provide access to different functions and options, such as help, undo, adding/removing target objects, etc.

Hence, a system is disclosed providing a user interface for programming the behaviour of a robot in dependence of the position of other objects and controlled by a state machine as described in connection with FIG. 9.

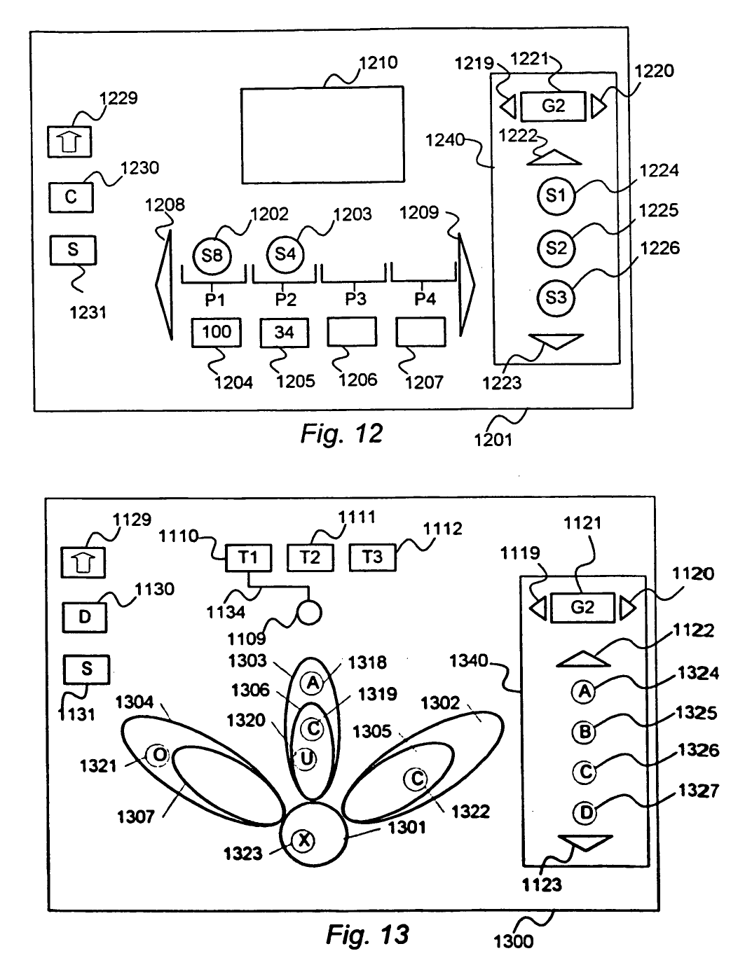

FIG. 12 shows a schematic view of a graphical user interface for editing action symbols. The user interface allows the editing of the actions associated with action symbols. As described above each action symbol in FIG. 11 may correspond to a high-level action which may be represented as a sequence of simpler actions. These will be referred to as primitive beads. When the user activates the editor for a given action symbol, the robot control system generates the user interface 1201.

The user interface comprises a description area 1210 presenting information about the action currently edited, such as a name, a description of the function, etc.

The sequence of primitive beads comprised in the current action is shown as a sequence of bead symbols 1202 and 1203 placed in their order of execution at predetermined location symbols P1, P2, P3, and P4. The location symbols have associated parameter fields 1204, 1205, 1206, and 1207, respectively, allowing a user to enter or edit parameters which may be associated with a primitive bead. Examples for such parameters include a time of a motion, a degree of rotation, the volume of a sound, etc. Alternatively or additionally, the parameters may be visualised and made controllable via other control elements, such as slide bars, or the like.

Furthermore, there may be more than one parameter associated to a primitive bead. The user interface further provides control elements 1208 and 1209 for scrolling through the sequence of primitive beads if necessary.

The user interface further provides a bead selection area 1240 comprising a list of selectable control elements 1224, 1225, and 1226 which represent primitive beads. The control elements may be activated with a pointing device, e.g. by a drag-and-drop operation to place a selected bead on one of the location symbols P1, P2, P3, or P4. Similar to the selection area 1140 described in connection with FIG. 11, the selection area 1240 comprises control elements 1222 and 1223 for scrolling through the list of primitive beads, and control elements 1219 and 1220 to select one of a number of groups of primitive beads as displayed in a display field 1221.

Furthermore, the user interface comprises a control element 1229 for navigating to other screens, e.g. to the robot configuration screen of FIG. 11, a control element 1230 for cancelling the current editing operation, and control element 1231 initiating a save operation of the edited bead. Alternatively or additionally, other control elements may be provided.

FIG. 13 shows a schematic view of another example of a graphical user interface for programming a robot. In this example, the robot is represented by a control element illustrated as a circle 1301. The user interface comprises area symbols 1302, 1303, 1304, 1305, 1306, and 1307, each representing a zone. The user interface further comprises an action symbol selection area 1140 as described in connection with FIG. 11. In this example the action beads are represented as labelled circles 1318-1327 which may be dragged and dropped within the area symbols in order to associate them with a certain zone. Preferably, the function of a bead is indicated by its label, its colour, shape, or the like.

In the example of FIG. 13, there are six area symbols representing six reception zones. Furthermore, the symbol 1301 representing the robot is a further control element in which action symbols may be dropped. These actions are performed when the target object is not detected in any zone. Table 3 illustrates how the reception zones shown in FIG. 5 are mapped into the zones in FIG. 13.

TABLE 3

| Area symbol | Zones |
|---|---|
| 1301 | target object not present |
| 1302 | MR |
| 1303 | MC |
| 1304 | ML |
| 1305 | LR |
| 1306 | LCR, LC, LCL |
| 1307 | LL |

Hence, according to this embodiment, the corresponding state machine execution system of the robot has seven action states associated with each behaviour state.

The user interface further comprises control elements for selecting a target object and further control elements for navigating to other screens, saving and downloading program scripts as described in connection with FIG. 11.

It is noted that the invention has been described in connection with a preferred embodiment of a toy robot for playing games where the toy robot uses infrared light emitters/receivers. It is understood that other detection systems and principles may be implemented. For example, a different number of emitters/receivers may be used and/or the emitters may be adapted to transmit signals at a single power level or at more than two power level, thereby providing a detection system with a different number of zones which provides a different level of accuracy in detecting positions.

Furthermore, other sensors may be employed, e.g. using radio-based measurements, magnetic sensors, or the like.

Furthermore, the described user-interface may use different techniques for activating control elements and for representing area symbols, action symbols, etc.

It is further understood that the invention may also be used in connection with mobile robots other than toy robots, e.g. mobile robots to be programmed by a user to perform certain tasks, e.g. in corporation with other mobile robots. Examples of such tasks include cleaning, surveillance, etc.

As mentioned above, a method according to the present invention may be embodied as a computer program. It is noted that a method according to the present invention may further be embodied as a computer program product arranged for causing a processor to execute the method described above. The computer program product may be embodied on a computer-readable medium. The term computer-readable medium may include magnetic tape, optical disc, digital video disk (DVD), compact disc (CD or CD-ROM), mini-disc, hard disk, floppy disk, ferro-electric memory, electrically erasable programmable read only memory (EEPROM), flash memory, EPROM, read only memory (ROM), static random access memory (SRAM), dynamic random access memory (DRAM), synchronous dynamic random access memory (SDRAM), ferromagnetic memory, optical storage, charge coupled devices, smart cards, PCMCIA card, etc.

1. A method of controlling a robot, the robot including detection means for detecting an object in a first one of a number of predetermined zones relative to the robot and for generating a detection signal identifying the first zone; and processing means for selecting and performing a predetermined action from a number of actions in response to said detection signal, the predetermined action corresponding to said first zone;
characterised in that
the method comprises
presenting to a user via a graphical user interface a number of area symbols each representing a corresponding one of the number of zones relative to the robot;
presenting to the user via the graphical user interface a plurality of action symbols, each action symbol representing at least one respective action of the robot;
receiving a user command indicating a placement of an action symbol corresponding to a first action in a predetermined relation to a first one of said area symbols corresponding to a first zone; and
generating an instruction for controlling the toy robot to perform the first action in response to detecting an object in the first zone.

2. A method according to claim 1, characterised in that the method further comprises the step of receiving a user command indicative of an identification of at least one selected target object; and the step of generating an instruction further comprises generating an instruction for controlling the toy robot to perform the first action in response to detecting the one of the at least one selected target objects in the first zone.

3. A method according to claim 1 or 2, characterised in that the detection means comprises a distance sensor adapted to generate a sensor signal indicative of a distance to the object; and each of the area symbols represents a predetermined range of distances from an object.

4. A method according to any one of claims 1 through 3, characterised in that the detection means comprises direction sensor means adapted to generate a sensor signal indicative of a direction to the object; and each of the area symbols represents a predetermined range of directions to an object.

5. A method according to any one of claims 1 through 4, characterised in that the detection means comprises orientation sensor means adapted to generate a sensor signal indicative of an orientation of the object; and each of the area symbols represents a predetermined range of orientations of an object.

6. A method according to any one of claims 1 through 5, characterised in that each of the action symbols corresponds to a sequence of predetermined physical actions of the toy robot.

7. A method according to any one of claims 1 through 6, characterised in that the step of generating an instruction comprises the step of generating instructions for a state machine executed by the robot.

8. A method according to claim 7, characterised in that the at least one selected target object corresponds to a first state of the state machine.

9. A method according to any one of claims 1 through 8, characterised in that the method further comprises generating a download signal including the generated instruction and communicating the download signal to the toy robot.

10. A system for controlling a robot, the robot including detection means for detecting an object in a first one of a number of predetermined zones relative to the robot and for generating a detection signal identifying the first zone; and processing means for selecting and performing a predetermined action from a number of actions in response to said detection signal, the predetermined action corresponding to said first zone;
characterised in that
the system comprises
means for generating a graphical user interface on a display screen, the graphical user interface having a number of area symbols each representing a corresponding one of the number of zones relative to the robot, and a plurality of action symbols, each action symbol representing at least one respective action of the robot;
input means adapted to receive a user command indicating a placement of an action symbol corresponding to a first action in a predetermined relation to a first one of said area symbols corresponding to a first zone; and
a processing unit adapted to generate an instruction for controlling the toy robot to perform the first action in response to detecting an object in the first zone.

11. A robot comprising
detection means for detecting an object in a first one of a number of predetermined zones relative to the robot and for generating a detection signal identifying the first zone;
processing means for selecting and performing a predetermined action from a number of actions in response to said detection signal, the predetermined action corresponding to said first zone;
characterised in that
the detection means is further adapted to identify the object as a first one of a number of predetermined target objects and to generate a corresponding identification signal;
the processing means is adapted to receive the detection and identification signals and to select and perform at least one of a number of actions depending on the identified first target object and on said detection signal identifying the first zone where the identified first target object is detected in.

12. A robot according to claim 11, characterised in that the processing means is adapted to implement a state machine
including a number of states each of which corresponds to one of a number of predetermined target object selection criteria;
a first selection module for selecting a first one of the number of states of the state machine in response to said identification signal; and
a second selection module for selecting one of a number of actions depending on the selected first state and depending on said detection signal identifying the first zone where the identified target object is detected in.

13. A robot according to claim 11 or 12, characterised in that the robot further comprises input means for receiving a download signal including instructions generated by a data processing system, the instructions corresponding user-defined actions in relation to corresponding target object identifications and zones.

14. A toy set comprising a robot according to any one of the claims 11 through 13.

15. A toy building set comprising a toy unit comprising a robot according to any one of the claims 11 through 13 characterized in that the toy unit comprises coupling means for inter-connecting with complementary coupling means on toy building elements.

16. A computer program comprising computer program code means for performing the method of any one of the claims 1 through 9 when run on a data processing system.
